(19) United States
(12) Patent Application Publication
(10) Pub. No.: US 2013/0175221 A1
(43) Pub. Date: Jul. 11, 2013

(54) ELECTRICALLY REGENERABLE WATER SOFTENING APPARATUSES AND METHODS OF OPERATING THE SAME

(71) Applicant: SAMSUNG ELECTRONICS CO., LTD., Suwon-Si (KR)

(72) Inventors: Hyun Seok KIM, Seoul (KR); Joon Seon JEONG, Seoul (KR); Bok Soon KWON, Seoul (KR); Dong Jin HAM, Anyang-si (KR); Hyo Rang KANG, Anyang-si (KR)

(73) Assignee: SAMSUNG ELECTRONICS CO., LTD., Suwon-Si (KR)

(21) Appl. No.: 13/735,502

(22) Filed: Jan. 7, 2013

(30) Foreign Application Priority Data
Jan. 9, 2012 (KR) 10-2012-0002637

(51) Int. Cl. B01J 49/00; C02F 1/42

(52) U.S. Cl. CPC B01J 49/0052; C02F 1/42
USPC 210/677; 210/190

(57) ABSTRACT

Electrically regenerable water softening apparatuses, and methods of operating the same, include a first electrode and a second electrode facing each other; a first electrolyte chamber, a first cation exchange membrane, an ion exchange chamber, a second cation exchange membrane, and a second electrolyte chamber which are interposed between the first electrode and the second electrode; an inflow water flow channel configured to introduce inflow water to the ion exchange chamber; a first treated water flow channel configured to discharge treated water softened in the ion exchange chamber; a second treated water flow channel connecting at least one chamber selected from the first electrolyte chamber and the second electrolyte chamber with an ion exchange chamber; and a current applier configured to apply current to the first electrode and the second electrode. The ion exchange chamber is filled with a cation exchanger.

### CROSS-REFERENCE TO RELATED APPLICATION

This application claims priority to and the benefit of Korean Patent Application No. 10-2012-0002637 filed in the Korean Intellectual Property Office on Jan. 9, 2012, the entire contents of which are incorporated herein by reference.

### BACKGROUND

1. Field

Electrically regenerable water softening apparatuses and methods of operating the same are disclosed.

2. Description of the Related Art

Tap water supplied for a house, or a factory, includes hardness components having different contents depending on the area the tap water is being used. Particularly, in Europe where a lot of limestone components enter into groundwater, the hardness of tap water is very high.

The heat exchanger of a home electric appliance, or an interior wall of a boiler pipe, using water having a high hardness is easily scaled, causing problems in that the energy efficiency is significantly decreased, and hard water is inappropriate for washing laundry. Generally, chemical methods are used in order to solve the problems. For example, the produced scale is removed using chemicals; hard water is softened using an ion exchange resin; and/or the contaminated ion exchange resin is regenerated by a large amount of chemicals having a high concentration.

However, the methods are inconvenient for users and have problems of environmental pollution or increased energy consumption, so simple and environmental-friendly techniques for softening hard water are increasingly required.

In order to substitute the chemical method of regenerating an ion exchange resin, techniques for combining the ion exchange and the electrodialysis have been required. Among the combined techniques, electro-deionization (EDI) has been industrially and commercially available for providing ultrapure water. The EDI technique includes passing an electrolyte (e.g., an acid) having a high concentration through an electrolyte chamber between an electrode and a cation exchange membrane to electrochemically regenerate the ion exchange resin, which is an environmental-friendly method. However, this technique additionally requires a pump for circulating the electrolyte having a high concentration and a chamber for storing the electrolyte, so the power consumption is increased and the device volume is enlarged.

### SUMMARY

Electrically regenerable water softening apparatuses and methods of operating the same are disclosed.

Example embodiments provide an electrically regenerable water softening apparatus that reduces the apparatus volume and the power consumption by using treated water as a regenerable electrolyte instead of an electrolyte having a concentration.

Example embodiments provide an environmental-friendly and electrically regenerable water softening apparatus that reduces the maintenance expenses for a user because it is regenerable.

Further example embodiments provide a method of driving the electrically regenerable water softening apparatus.

According to example embodiments, provided is an electrically regenerable water softening apparatus that includes a first electrode and a second electrode facing each other; a first electrolyte chamber, a first cation exchange membrane, an ion exchange chamber filled with a cation exchanger, a second cation exchange membrane, and a second electrolyte chamber which are interposed between the first electrode and the second electrode; an inflow water flow channel configured to introduce inflow water to the ion exchange chamber; a first treated water flow channel configured to discharge treated water softened in the ion exchange chamber; a second treated water flow channel connecting at least one chamber selected from the first electrolyte chamber and the second electrolyte chamber with an ion exchange chamber; and a current applier configured to apply a current to the first electrode and the second electrode.

The inflow water has a concentration of hardness ions. The inflow water flow channel may be configured to introduce the inflow water having the concentration of hardness ions into the ion exchange chamber. The inflow water may include a concentration of about 50 ppm to about 500 ppm, specifically about 70 ppm to about 400 ppm, more specifically about 100 ppm to about 300 ppm, and still more specifically about 150 ppm to about 250 ppm of hardness ions.

The inflow water flow channel may introduce the inflow water at a flow velocity of about 3 ml/min to about 30 ml/min relative to 1 ml of the cation exchanger. The inflow water flow channel may introduce the inflow water at a flow rate of about 15 ml to about 150 ml relative to 1 ml of the cation exchanger.

The cation exchanger may be selected from a cation exchange resin, a cation exchange fiber, cation exchange cloth, activated carbon, a metal mesh, and a combination thereof.

The second treated water flow channel may connect the first electrolyte chamber to the ion chamber, and the electrically regenerable water softening apparatus may further include a third treated water flow channel configured to supply the treated water passed through the second treated water flow channel to the second electrolyte chamber.

The treated water may have a pH of 2 to 5. The second treated water flow channel may be configured to supply the treated water having about pH 2 to about pH 5.

The cation exchanger may be regenerable by applying the current to the first and second electrodes while supplying at least a part of the treated water from the ion exchange chamber into at least one of the first electrolyte chamber and the second electrolyte chamber.

According to other example embodiments, provided is a method of driving the electrically regenerable water softening apparatus that includes supplying the inflow water into the ion exchange chamber of the electrically regenerable water softening apparatus without applying current to adsorb hardness ions in the inflow water; and applying a first current to the first electrode and the second electrode while supplying a part of treated water from the ion exchange chamber into at least one of the first electrolyte chamber and the second electrolyte chamber to regenerate the cation exchanger.

The inflow water may be supplied at a flow velocity of about 3 ml/min to about 30 ml/min relative to 1 ml of the cation exchanger. The inflow water may be supplied at a flow rate of about 15 ml to about 150 ml relative to 1 ml of the cation exchanger.

Applying the first current to regenerate the cation exchanger may include applying a second current opposite to the first current to the first electrode and the second electrode, after a set time has passed.

A second current, opposite to the first current, may be applied to the first electrode and the second electrode, after regenerating the cation exchanger.

Adsorbing the hardness ions and regenerating the cation exchanger may be repeated, and a second current opposite to the first current may be applied to the first electrode and the second electrode while repeating the regenerating of the cation exchanger.

One selected from the first electrolyte chamber and the second electrolyte chamber may have hydroxyl (OH⁻) ions produced by electrolyzing water, and the method may include passing the treated water through the OH⁻ ions, after regenerating the cation exchanger.

According to further example embodiments, a method of driving an electrically regenerable water softening apparatus is provided that includes supplying inflow water to an ion exchange chamber of the electrically regenerable water softening apparatus to absorb hardness ions in the inflow water; and stopping a flow of the inflow water; and applying a first current to a first electrode and a second electrode while supplying a part of the treated water from the ion exchange chamber to at least one of a first electrolyte chamber and a second electrolyte chamber to regenerate a cation exchanger of the electrically regenerable water softening apparatus.

The inflow water may be supplied at a flow velocity of about 3 ml/min to about 30 ml/min relative to 1 ml of the cation exchanger. The inflow water may be supplied at a flow rate of about 15 ml to about 150 ml relative to 1 ml of the cation exchanger.

Applying the first current to regenerate a cation exchanger may further include applying a second current opposite to the first current to the first electrode and the second electrode after a set time has passed.

The method of driving an electrically regenerable water softening apparatus may further include applying a second current opposite to the first current to the first electrode and the second electrode after regenerating a cation exchanger.

Adsorbing the hardness ions and the regenerating the cation exchanger may be repeated, and a second current opposite to the first current may be applied while repeating the regenerating of the cation exchanger.

One selected from the first electrolyte chamber and the second electrolyte chamber may have hydroxyl (OH) ions produced by electrolyzing water, and the method of driving an electrically regenerable water softening apparatus may include further passing the treated water through the OH⁻ ions after regenerating the cation exchanger.

A second current may be applied to the ion exchange chamber while supplying the inflow water.

### BRIEF DESCRIPTION OF THE DRAWINGS

Example embodiments will be more clearly understood from the following detailed description taken in conjunction with the accompanying drawings. FIGS. 1-6 represent non-limiting, example embodiments as described herein.

FIG. 1 is a schematic view of an electrically regenerable water softening apparatus according example embodiments.

FIG. 2 is a schematic view of an electrically regenerable water softening apparatus according to example embodiments.

FIG. 3 is a schematic view of an electrically regenerable water softening apparatus according to example embodiments.

FIG. 4 is a schematic view of an electrically regenerable water softening apparatus fabricated according to Comparative Example 1.

FIG. 5 is a schematic view of an electrically regenerable water softening apparatus fabricated according to Comparative Example 2.

FIG. 6 is a view showing the removal rate results of hardness ions present in treated water with respect to inflow water after driving the electrically regenerable water softening apparatus obtained from Example 1, Example 2, Comparative Example 1, and Comparative Example 2 as a percentage.

### DETAILED DESCRIPTION

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the invention.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the present invention is not limited to example embodiments described.

Electrically regenerable water softening apparatuses and methods of operating the same are disclosed.

Hereinafter, referring to the drawings, an electrically regenerable water softening apparatus according to example embodiments are described in detail.

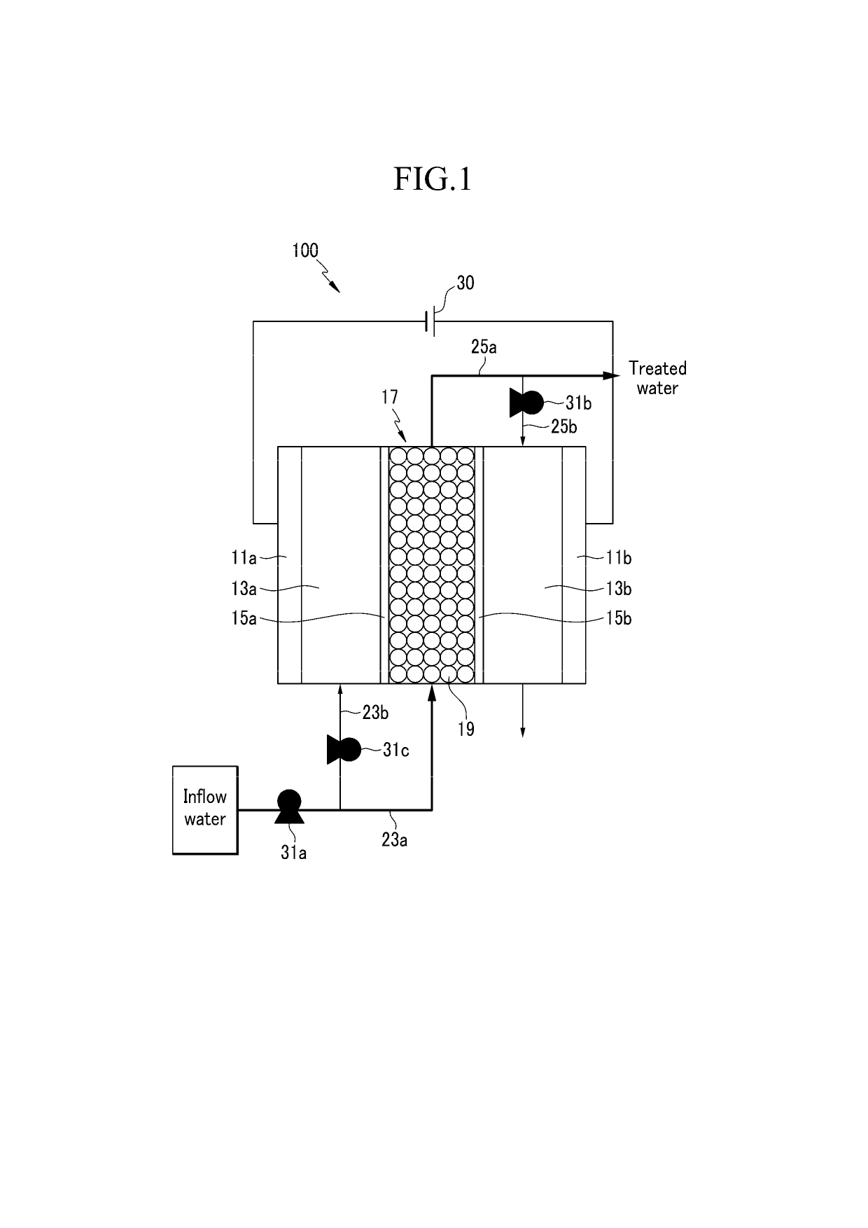

FIG. 1 is a schematic view of an electrically regenerable water softening apparatus according example embodiments.

Referring to FIG. 1, an electrically regenerable water softening apparatus 100 includes a cathode (first electrode, 11a) and an anode (second electrode, 11b); a first electrolyte chamber 13a, a first cation exchange membrane 15a, an ion exchange chamber 17, a second cation exchange membrane 15b, and a second electrolyte chamber 13b, which are interposed between the cathode 11a and anode 11b; an inflow water flow channel 23a configured to introduce inflow water to the ion exchange chamber 17; a first treated water flow channel 25a configured for treating water softened in the ion exchange chamber 17; and a second treated water flow channel 25b connecting the second electrolyte chamber 13b and the ion exchange chamber 17. The ion exchange chamber 17 is filled with a cation exchanger 19.

The second treated water flow channel 25b may include a pump 31b configured to control the flow velocity or the flow rate of treated water.

The cathode 11a and anode 11b may include a material configured to induce a water decomposition reaction. The material configure to induce a water decomposition reaction may include a metal, a metal oxide, a metal carbide, stainless steel, glassy carbon, graphite, carbon black, or a combination thereof. Herein, the combination refers to a mixture, a stacking structure, or the like, of two or more components. The metal may be selected from platinum (Pt), titanium (Ti), ruthenium (Ru), silver (Ag), gold (Au), iridium (Ir), palladium (Pd), cobalt (Co), vanadium (V), iron (Fe), tungsten (W), and a combination thereof. Herein, the combination refers to a mixture, an alloy, a stacking structure, or the like, of two or more metals. The metal carbide may be selected from WC, TiC, Mo₂C, and a combination thereof. The metal oxide may be selected from PtO₂, IrO₂, SnO₂, TiO₂, CaTiO₃, NaWO₃, MnO₂, RuO₂, PbO₂, and a combination thereof. Herein, the combination refers to a mixture, a stacking structure, or the like, of two or more metal oxides. Examples of the combinations of two or more components may include Pt/Ti, IrO₂/Ti, RuO₂/Ti, SnO₂/Ti, PbO₂/Ti, and the like.

The water electrolysis shown in the following Reaction Scheme 1 may be performed in the cathode 11a and the anode 11b, respectively.

Cathode: 2H₂O+2e⁻→H₂+2OH⁻

Anode: 2H₂O→O₂+4H⁺+4e⁻ Reaction Scheme 1

The first cation exchange membrane 15a and the second cation exchange membrane 15b may include a resin in which the cation exchange group is substituted in a polyolefin-based resin. The polyolefin-based resin may include polyethylene, polypropylene, and the like, and the cation exchange group may include a sulfonic acid group, a carboxyl group, a phosphoric acid group, a phenolic hydroxyl group, and the like, but are not limited thereto.

The first cation exchange membrane 15a prevents the transport of hydroxyl ions (OH⁻) generated from cathode 11a into the ion exchange chamber 17, and the second cation exchange membrane 15b selectively transports protons (H+) produced from the anode 11b into the ion exchange chamber 17. Protons (H+) transported into the ion exchange chamber 17 fill vacancies generated by transporting cations bound to the cation exchanger 19 into the cathode 11a.

The cation exchanger 19 of the ion exchange chamber 17 may be selected from a cation exchange resin, a cation exchange fiber, cation exchange cloth, activated carbon, a metal mesh, and a combination thereof. The cation exchanger 19 removes heavy metals, or polyvalent cations, included in inflow water to convert inflow water (hard water) to soft water.

The electrically regenerable water softening apparatus 100 includes the inflow water flow channel 23a configured to input inflow water having a high concentration of hardness ions. The inflow water may include about 50 ppm to about 500 ppm, specifically about 70 ppm to about 400 ppm, more specifically about 100 ppm to about 300 ppm, and still more specifically about 150 ppm to about 250 ppm of hardness ions. The electrically regenerable water softening apparatus 100 may electrochemically regenerate the cation exchanger 19, which is environmental-friendly, so inflow water having a high concentration of hardness ions may be treated. The inflow water having a high concentration of hardness ions may provide treated water having a high proton (H⁺) concentration when the hardness ions are removed after passing through the ion exchange chamber 17. The treated water may have a pH of about 2 to about 5. In addition, the treated water may have an ion conductivity of about 700×10⁻⁶ S/cm to about 2500×10⁻⁶ S/cm. In this case, the treated water is supplied as an electrolyte having a high concentration of hardness ions into the second electrolyte chamber 13b to reduce the resistance while passing through the electrolyte chamber, so as to reduce the electrochemical energy in the regeneration.

The inflow water flow channel 23a may supply inflow water at a flow velocity of about 3 ml/min to about 30 ml/min relative to 1 ml of the cation exchanger 19. In this case, the hardness ions may be more effectively removed from the inflow water.

The inflow water flow channel 23a may supply inflow water at a flow rate of about 15 ml to about 150 ml relative to 1 ml of the cation exchanger. In this case, the hardness ions may be even more effectively removed from the inflow water.

The inflow water flow channel 23a may include a pump 31a configured to control the flow velocity or the flow rate of inflow water.

Inflow water may be supplied into the first electrolyte chamber 13a through an inflow water flow channel 23b. The inflow water flow channel 23b may include a pump 31c configured to control the flow velocity or the flow rate of the inflow water.

Treated water is supplied to the ion exchange chamber 17 through the second treated water flow channel 25b connecting the second electrolyte chamber 13b to the ion exchange chamber 17 while a current is applied to the cathode 11a and the anode 11b by an operating current applier 30, so the cation exchanger 19 may be regenerated by removing metal ions adsorbed in the cation exchanger 19. Thereby, it is environmental-friendly because the cation exchanger 19 is regenerated according to the electrochemical method instead of using chemicals. In addition, a chamber configured to store electrolyte having a high concentration of hardness ions, a pump configured to circulate the electrolyte having a high concentration of hardness ions, or the like is not required because the electrolyte having a high concentration of hardness ions does not need to be circulated as regenerated water. Accordingly, the device volume may be reduced, and the electric power consumption for a circulation pump may be saved.

Inflow water may be supplied to an electrolyte chamber which is not supplied with treated water among the first electrolyte chamber 13a and the second electrolyte chamber 13b. FIG. 1 shows that the second treated water flow channel 25b connects the second electrolyte chamber 13b to the ion exchange chamber 17, and that the inflow water flow channel 23a and the pump 31c controlling the inflow water flow channel 23a are connected to the first electrolyte chamber 13a. Alternatively, the second treated water flow channel 25b may be adopted to connect the first electrolyte chamber 13a and the ion exchange chamber 17, and the inflow water flow channel 23a and the pump 31a controlling the same may be connected to the second electrolyte chamber 13b.

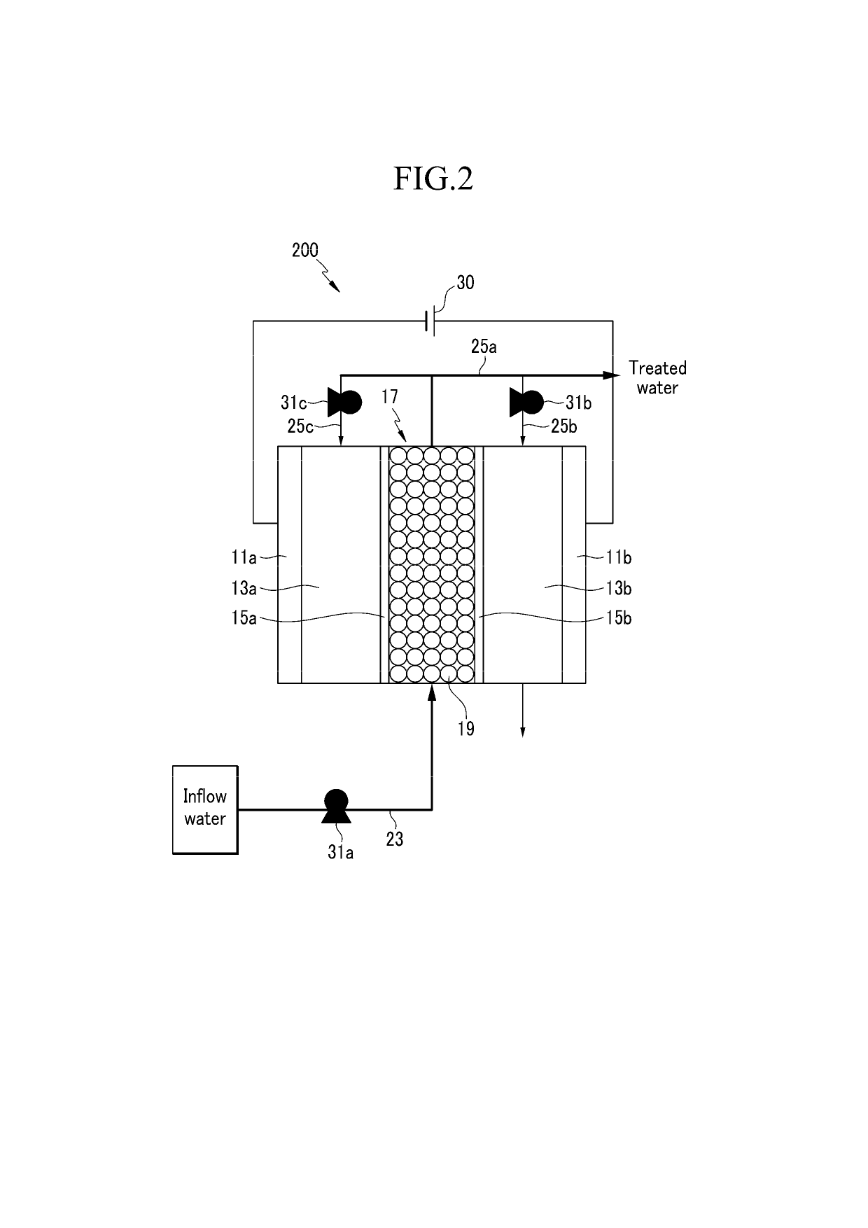

FIG. 2 is a schematic view of an electrically regenerable water softening apparatus according to other example embodiments.

Referring to FIG. 2, an electrically regenerable water softening apparatus 200 includes a third treated water flow channel 25c supplying a part of treated water having passed through the ion exchange chamber 17 into the first electrolyte chamber 13a, and the second treated water flow channel 25b simultaneously supplying a part of treated water to the second electrolyte chamber 13b. A pump 31c controlling the supply of treated water is also mounted in the third treated water flow channel 25c.

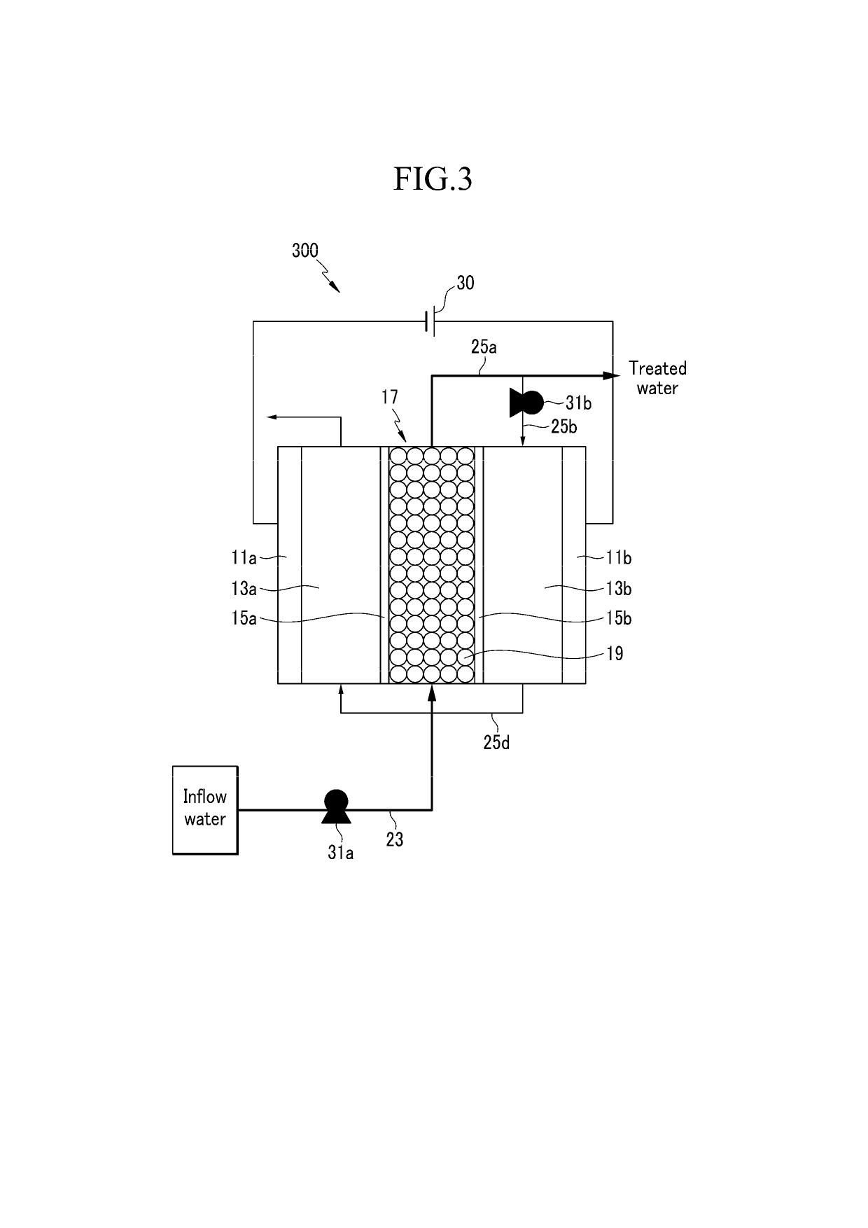

FIG. 3 is a schematic view of an electrically regenerable water softening apparatus according to yet other example embodiments.

Referring to FIG. 3, an electrically regenerable water softening apparatus 300 includes a fourth treated water flow channel 25d supplying treated water having passed through the second treated water flow channel 25b connecting the ion exchange chamber 17 to the second electrolyte chamber 13b into the first electrolyte chamber 13a. Alternatively, the electrically regenerable water softening apparatus 300 may include a treated water flow channel supplying treated water having passed through a treated water flow channel connecting the ion exchange chamber 17 to the first electrolyte chamber 13a into the second electrolyte chamber 13b.

According to still other example embodiments, a method of driving an electrically regenerable water softening apparatus is provided.

First, inflow water is supplied into the ion exchange chamber 17 of the electrically regenerable water softening apparatus (e.g., the electrically regenerable water softening apparatuses 100, 200, or 300 shown in FIG. 1, 2 or 3, respectively) without applying a current, so as to absorb hardness ions. Then, while a part of treated water having come from the ion exchange chamber 17 is supplied into at least one of the first electrolyte chamber 13a and the second electrolyte chamber 13b, current is applied to the cathode 11a and the anode 11b to regenerate the cation exchanger 19. The applied current may be adjusted with regard to the amount of cation exchanger, and may have a current density of about 4 mA/cm² to about 20 mA/cm².

According to other example embodiments, inflow water is supplied into the exchange chamber 17 of the electrically regenerable water softening apparatus 100, 200, or 300 simultaneously while applying a current, so as to adsorb hardness ions. Then the inflow water supply is stopped, and current is applied to the cathode 11a and the anode 11b while supplying a part of treated water having come from the ion exchange chamber 17 to at least one of the first electrolyte chamber 13a and the second electrolyte chamber 13b to regenerate the cation exchanger 19. The applied current may be adjusted depending upon the amount of cation exchanger, and may have a current density of about 4 mA/cm² to about 20 mA/cm².

The adsorption process and the regeneration process may be cycled according to a set time period, or in real time, depending upon the results of measuring or monitoring a flow rate of treated water, a flow velocity of treated water, and/or a concentration of hardness ions in treated water. In order to measure or monitor in real time, the electrically regenerable water softening apparatus 100, 200, or 300 may further include a sensor, or a monitoring system, configured to sense the hydrodynamic, or electrical, characteristics of treated water.

The method may further include supplying treated water having passed through the treated water flow channel connecting the first electrolyte chamber 13a with the ion exchange chamber 17 to a second electrolyte chamber 13b, or supplying treated water having passed through the treated water flow channel connecting the second electrolyte chamber 13b with the ion exchange chamber 17 to the first electrolyte chamber 13a.

While applying a current, opposite currents may be applied to the cathode 11a and the anode 11b after a set time has passed. In addition, after regenerating the cation exchanger 19, opposite currents may be applied to the cathode 11a and the anode 11b. In addition, the adsorption step and the regeneration step of the cation exchanger 19 may be repeated in a set period, and a current opposite to that of the regeneration step of a first cycle may be applied in the regeneration step of a second cycle. The potential of the cathode 11a and anode 11b is reversed by applying opposite currents, so the hardness ions absorbed to the cathode 11a and the anode 11b, or the hardness ions absorbed to the inner membrane of the first electrolyte chamber 13a and the second electrolyte chamber 13b, may be reacted with negative ions to remove the produced scale. The scale may include CaCO₃, Ca(OH)₂, Mg(OH)₂, or the like, but is not limited thereto.

After regenerating the cation exchanger 19, treated water may be further passed through the electrolyte chamber where OH⁻ions are produced by decomposing water that contacts the cathode, among the first electrolyte chamber 13a and the second electrolyte chamber 13b. By the processes, any scale present in the electrolyte chamber may be removed.

Hereinafter, the embodiments are illustrated in more detail with reference to examples. However, the following are example embodiments and are not limiting.

### EXAMPLE 1

### Manufacture and Operation of Electrically Regenerable Water Softening Apparatus

1.5 ml of CMP28 (manufactured by Iontec) is charged as a cation exchanger in an ion exchange chamber, and a Neosepta CMX (Tokuyama, Japan) is used as a cation exchange membrane. As a cathode and an anode, Ti/Pt plates are used to provide an electrically regenerable water softening apparatus having a structure as shown in FIG. 3.

Inflow water including about 250 ppm (as CaCO₃) of hardness ions is flowed into the ion exchange chamber of the electrically regenerable water softening apparatus for 30 minutes to saturate the cation exchanger with Ca²⁺ or Mg²⁺ ions (hardness ions) to about 70% based on the theoretical exchange amount (pre-adsorption process). Then inflow water is flowed into the ion exchange chamber for about 5 minutes at a flow velocity of 20 ml/min to adsorb Ca²⁺ ions with the cation exchanger. While flowing treated water from the ion exchange chamber at a speed of 5 ml/min for 40 minutes, a current is applied at a current density of 10 mA/cm² to regenerate a cation exchanger. The treated water from the ion exchange chamber has an ion conductivity of about 1650×10⁻⁶ S/cm. The adsorption and regeneration process is repeated 7 times, and the polarity of the electrode is reversed in the regeneration process of each cycle.

### EXAMPLE 2

### Manufacture and Operation of Electrically Regenerable Water Softening Apparatus

An electrically regenerable water softening apparatus shown in FIG. 3 is fabricated and driven in accordance with the same procedure as in Example 1, except for using inflow water including about 100 ppm (as CaCO₃) of hardness ions instead of inflow water including about 250 ppm (as CaCO₃) of hardness ions.

### COMPARATIVE EXAMPLE 1

### Manufacture and Operation of Electrically Regenerable Water Softening Apparatus

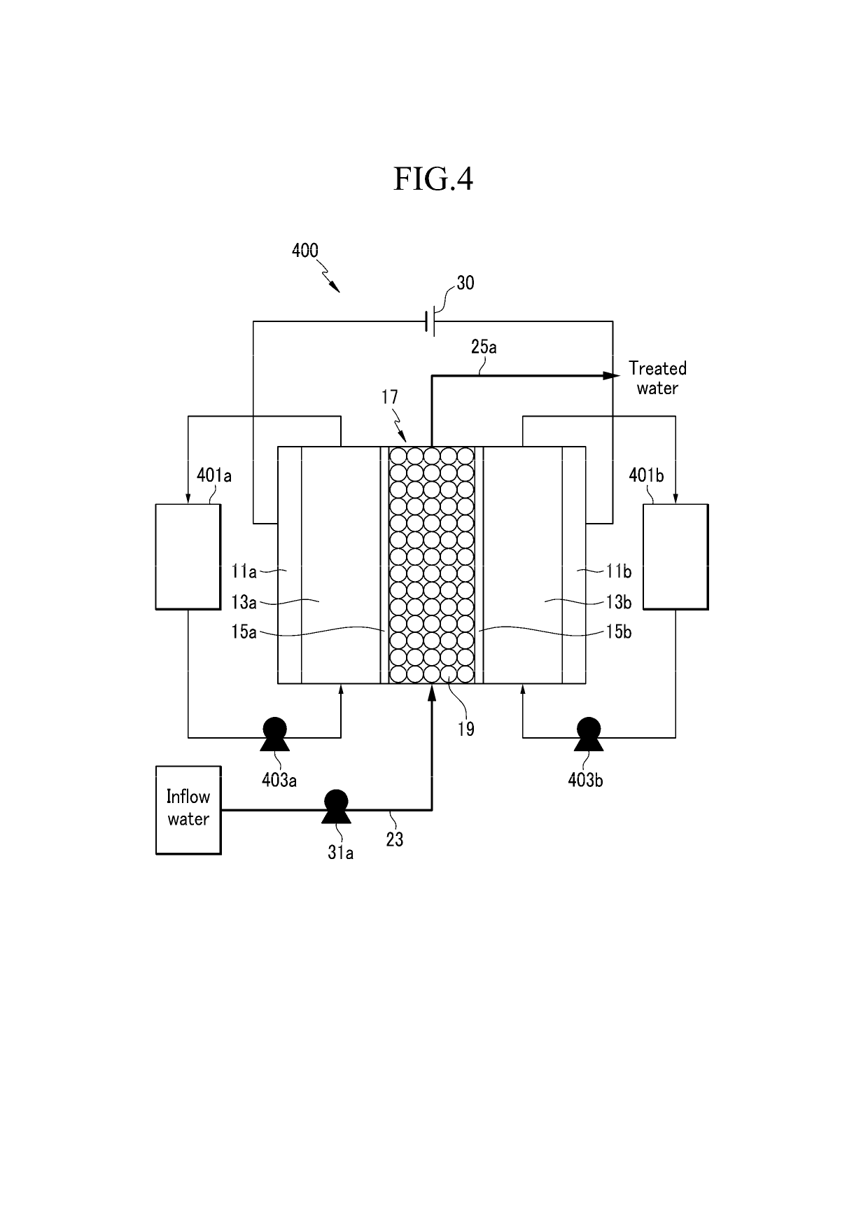

1.5 ml of a cation exchanger of CMP28 (manufactured by lontec) is charged in an ion exchange chamber, and a cation exchange membrane of Neosepta CMX (Tokuyama, Japan) and a cathode and an anode of Ti/Pt plates are used to provide an electrically regenerable water softening apparatus 400 shown in FIG. 4.

FIG. 4 is a schematic view of an electrically regenerable water softening apparatus fabricated according to Comparative Example 1.

In FIG. 4, the same members are used to designate the same symbols as in FIG. 1. An electrically regenerable water softening apparatus 400 shown in FIG. 4 further includes an electrolyte chamber 401a configured to circulate an electrolyte having a high concentration of hardness ions into a first electrolyte chamber 13a and a pump 403a configured to control the same, and an electrolyte chamber 401b configured to circulate an electrolyte having a high concentration of hardness ions into the second electrolyte chamber 13b and a pump 403b configured to control the same, in addition to the electrically regenerable water softening apparatus shown in FIG. 1, but does not include the second treated water flow channel 25b or the pump 31b configured to control the same.

Inflow water including about 250 ppm (as CaCO₃) of hardness ions is flowed into the ion exchange chamber 17 of the electrically regenerable water softening apparatus 400 for 30 minutes to saturate the cation exchanger 19 with Ca²⁺ ions (hardness ions) (pre-adsorption process). Then inflow water is flowed into the ion exchange chamber 17 for about 5 minutes at a flow velocity of 20 ml/min to adsorb Ca²⁺ ions with the cation exchanger. While flowing 0.2 M of H₂SO₄, which is an electrolyte having a high concentration, at a speed of 5 ml/min for 40 minutes, a current is applied at 10 mA/cm² to regenerate the cation exchanger. The adsorption and regeneration process is repeated 7 times, and the polarity of the electrode is reversed in the regeneration process of each cycle.

### COMPARATIVE EXAMPLE 2

### Manufacture and Operation of Electrically Regenerable Water Softening Apparatus

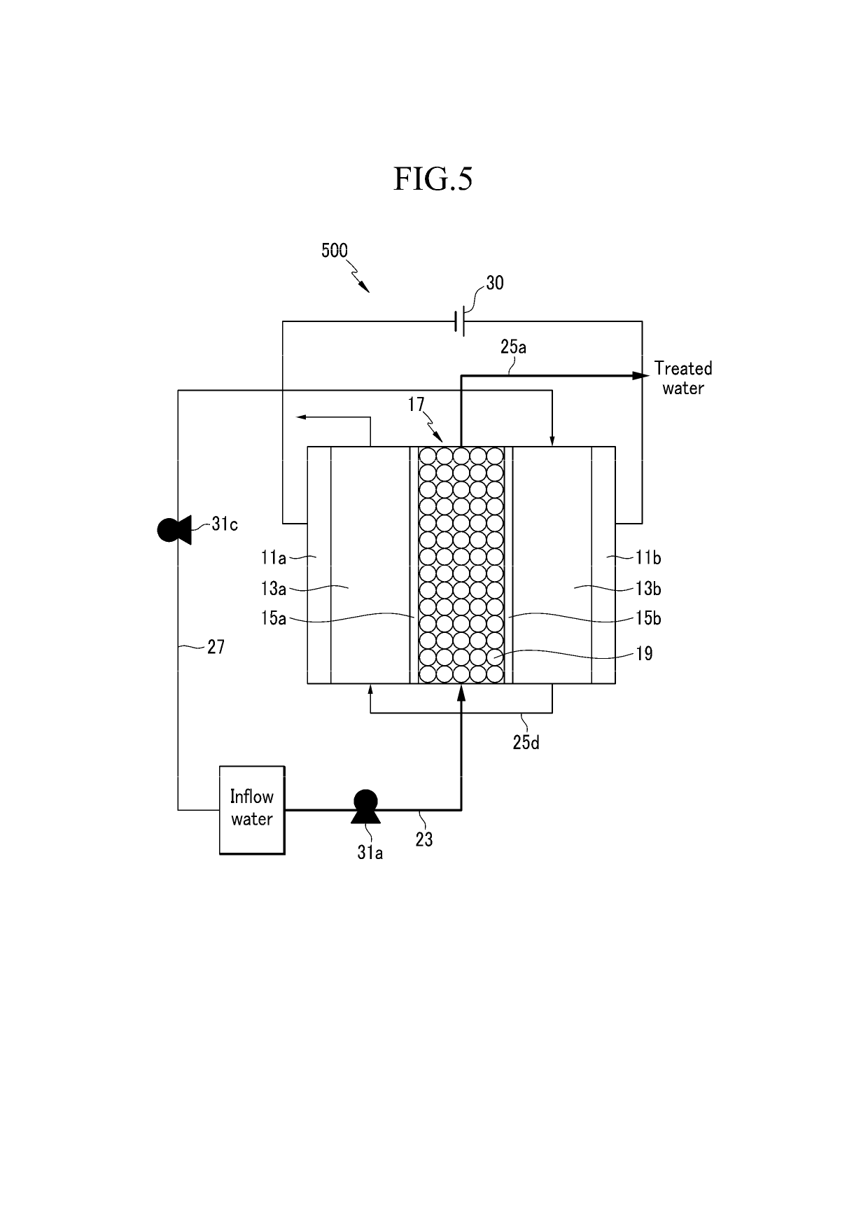

FIG. 5 is a schematic view of an electrically regenerable water softening apparatus fabricated according to Comparative Example 2.

Referring FIG. 5, an electrically regenerable water softening apparatus 500 is fabricated so that the second treated water flow channel 25b is omitted from the electrically regenerable water softening apparatus 300 shown in FIG. 3, and a treated water flow channel 27 and a pump 31c are mounted to supply inflow water to the second electrolyte chamber 13b.

Inflow water including about 250 ppm (as CaCO₃) of hardness ions is flowed into the ion exchange chamber 17 of the electrically regenerable water softening apparatus 500 for 30 minutes to saturate the cation exchanger with Ca²⁺ ions (hardness ions) (pre-adsorption process). Then inflow water is flowed into the ion exchange chamber 17 for about 5 minutes at a flow velocity of 20 ml/min to adsorb Ca²⁺ ions with the cation exchanger. While flowing inflow water including about 250 ppm (as CaCO₃) of hardness ions at a speed of 5 ml/min for 40 minutes, a current is applied at a current density of 10 mA/cm² to regenerate the cation exchanger. The inflow water has an ion conductivity of about 650×10⁻⁶ S/cm. The adsorption and regenerate process is repeated 7 times, and the polarity of the electrode is reversed in the regeneration process of each cycle.

### Hardness Ion Removal Rate

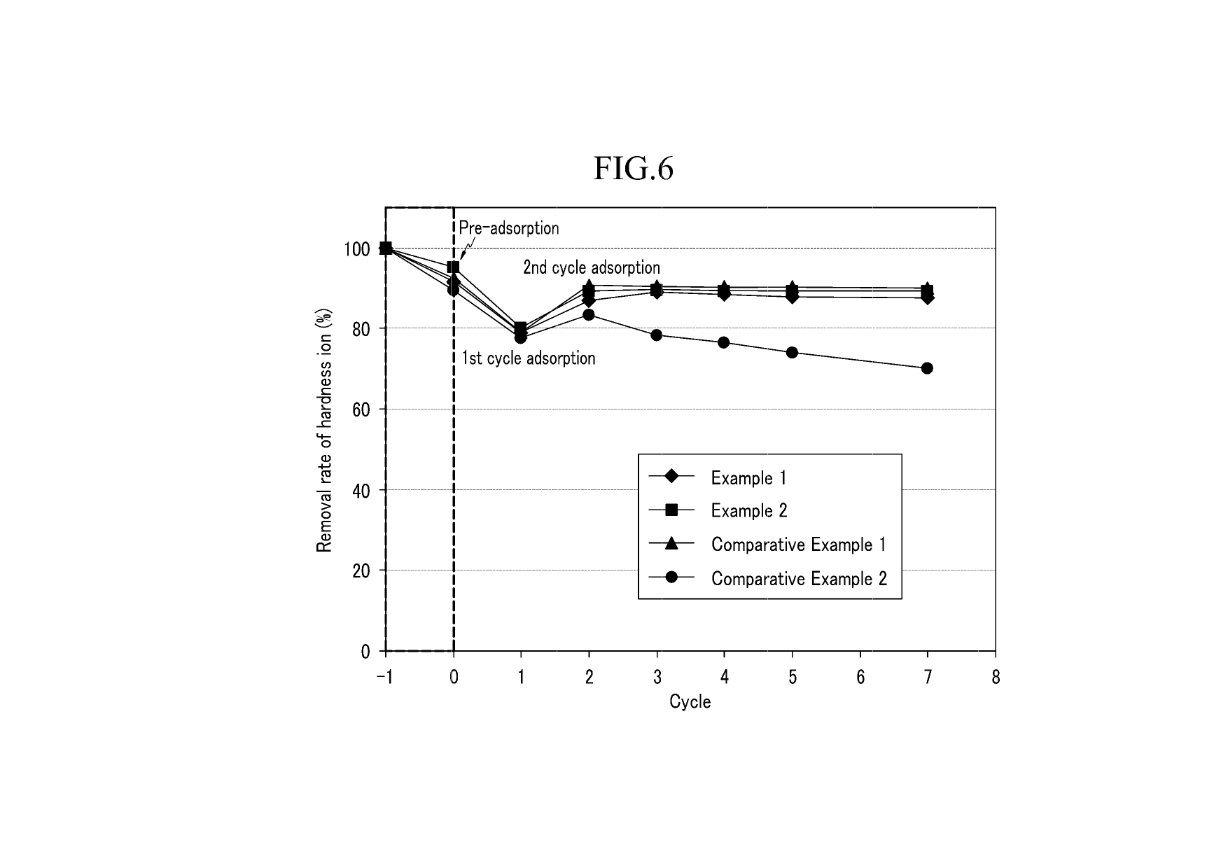

FIG. 6 is a view showing the removal rate results of hardness ions present in treated water with respect to inflow water after driving the electrically regenerable water softening apparatus obtained from Example 1, Example 2, Comparative Example 1, and Comparative Example 2 as a percentage.

After driving the electrically regenerable water softening apparatus obtained from Example 1, Example 2, Comparative Example 1, and Comparative Example 2, the percentage of hardness ions present in treated water relative to inflow water (hereinafter referred to as “hardness ion removal rate”) is measured, and the results are shown in FIG. 6.

As shown in FIG. 6, the electrically regenerable water softening apparatus obtained from Example 1, Example 2, Comparative Example 1, and Comparative Example 2 decrease the hardness ion removal rate to 80% during the first cycle, but Example 1 and Example 2 using treated water as a regenerable electrolyte show a hardness ion removal rate of greater than, or equal to, 90% after the second cycle of performing the regeneration process. That is comparable to the hardness ion removal rate of Comparative Example 1 including an electrolyte having a high concentration. In contrast, it is confirmed that Comparative Example 2 using inflow water as a regenerable electrolyte has a decreased hardness ion removal rate according to repeated cycles.

### Power Consumption

Using each electrically regenerable water softening apparatus obtained from Example 1, Example 2, Comparative Example 1, and Comparative Example 2, the energy consumed for softening 15 L of inflow water (hard water) having a concentration of hardness ions of 250 ppm per cycle is shown in the following Table 1.

TABLE 1

| | COMPARATIVE | COMPARATIVE | | |
|---|---|---|---|---|
| | EXAMPLE 1 | EXAMPLE 2 | EXAMPLE 1 | EXAMPLE 2 |
| NUMBER OF PUMPS | 3 | 2 | 2 | 2 |
| ENERGY CONSUMED | 225 Wh | 150 Wh | 150 Wh | 150 Wh |
| FOR OPERATION OF PUMP | | | | |
| (75 W CLASS) | | | | |
| ELECTROCHEMICAL | 28 Wh | 98 Wh | 75 Wh | 97 Wh |
| REGENERATION ENERGY | | | | |
| (BASED ON 1 HOUR | | | | |
| REGENERATION) | | | | |
| TOTAL CONSUMPTION | 253 Wh | 246 Wh | 225 Wh | 247 Wh |
| ENERGY | | | | |

As shown in Table 1, it is understood that the electrically regenerable water softening apparatus according to Comparative Example 1 including an electrolyte having a high concentration of hardness ions consumes less electrochemical regeneration energy, but the total energy consumption is insignificantly different from those of the electrically regenerable water softening apparatus according to Example 1 and Example 2 by adding the pump energy for circulating the electrolyte having a high concentration to the electrolyte chamber. The electrically regenerable water softening apparatus according to Comparative Example 2 using inflow water as a regenerable electrolyte, and Example 1 and Example 2 using treated water as a regenerable electrolyte do not require a pump for circulating an electrolyte having a high concentration, so energy is saved; but it is confirmed that Comparative Example 2 increases energy consumption for the electrochemical reaction due to the increase of electrical resistance compared to Example 1 and Example 2. That is considered to be because hardness ion components included in inflow water are transported from the electrolyte chamber into the ion exchange chamber by using inflow water (hard water) to substitute the ion exchanger with the hardness ion component. From the results, the electrically regenerable water softening apparatus according to Example 1 and Example 2 use treated water as a regenerable electrolyte, so a pump for circulating the electrolyte having a high concentration is not required. Thereby, it is understood that the pump cost and the energy for operating the pump may be reduced, and the apparatus volume may be reduced. In addition, treated water from which hardness ion components are removed to be softened is used as a regenerable electrolyte, so the resistance of the electrolyte chamber may be reduced to save electrochemical energy during regeneration.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

### <Description of Symbols>

100, 200, 300, 400, 500: electrically regenerable water softening apparatus

11a: cathode

11b: anode

13a: first electrolyte chamber

13b: second electrolyte chamber

15a: first cation exchange membrane

15b: second cation exchange membrane

17: ion exchange chamber

19: ion exchanger

23a, 23b: inflow water flow channel

25a: first treated water flow channel

25b, 25c: second treated water flow channel

30: current applier

31a, 31b, 31c: pump

What is claimed is:

1. An electrically regenerable water softening apparatus, comprising:
a first electrode and a second electrode facing each other;
a first electrolyte chamber, a first cation exchange membrane, an ion exchange chamber filled with a cation exchanger, a second cation exchange membrane, and a second electrolyte chamber, which are interposed between the first electrode and the second electrode;
an inflow water flow channel configured to introduce inflow water to the ion exchange chamber;
a first treated water flow channel configured to discharge treated water softened in the ion exchange chamber;
a second treated water flow channel connecting at least one chamber selected from the first electrolyte chamber and the second electrolyte chamber with the ion exchange chamber; and
a current applier configured to apply a current to the first electrode and the second electrode.

2. The electrically regenerable water softening apparatus of claim 1, wherein the inflow water has a concentration of hardness ions; and
the inflow water flow channel is configured to introduce the inflow water having the concentration of hardness ions into the ion exchange chamber.

3. The electrically regenerable water softening apparatus of claim 2, wherein the concentration of hardness ions in the inflow water is about 50 ppm to about 500 ppm.

4. The electrically regenerable water softening apparatus of claim 2, wherein the concentration of hardness ions in the inflow water is about 150 ppm to about 250 ppm.

5. The electrically regenerable water softening apparatus of claim 1, wherein the inflow water flow channel introduces the inflow water at a flow velocity of about 3 ml/min to about 30 ml/min relative to 1 ml of the cation exchanger.

6. The electrically regenerable water softening apparatus of claim 1, wherein the inflow water flow channel introduces the inflow water at a flow rate of about 15 ml to about 150 ml relative to 1 ml of the cation exchanger.

7. The electrically regenerable water softening apparatus of claim 1, wherein the cation exchanger is selected from a cation exchange resin, a cation exchange fiber, cation exchange cloth, activated carbon, a metal mesh, and combination thereof.

8. The electrically regenerable water softening apparatus of claim 1, wherein the second treated water flow channel connects the first electrolyte chamber to the ion exchange chamber, and
the electrically regenerable water softening apparatus further comprises a third treated water flow channel configured to supply the treated water passed through the second treated water flow channel to the second electrolyte chamber.

9. The electrically regenerable water softening apparatus of claim 1, wherein the treated water has a pH of 2 to 5, and
the second treated water flow channel is configured to supply the treated water of pH 2 to 5.

10. The electrically regenerable water softening apparatus of claim 1, wherein the cation exchanger is regenerable by applying the current to the first and second electrodes while supplying at least a part of the treated water from the ion exchange chamber into at least one of the first electrolyte chamber and the second electrolyte chamber.

11. A method of driving an electrically regenerable water softening apparatus, comprising:
supplying the inflow water into the ion exchange chamber of the electrically regenerable water softening apparatus according to claim 1 without applying a current to adsorb hardness ions in the inflow water; and
applying a first current to the first electrode and the second electrode while supplying a part of the treated water from the ion exchange chamber into at least one of the first electrolyte chamber and the second electrolyte chamber to regenerate the cation exchanger.

12. The method of claim 11, wherein the inflow water is supplied at a flow velocity of about 3 ml/min to about 30 ml/min relative to 1 ml of the cation exchanger.

13. The method of claim 11, wherein the inflow water is supplied at a flow rate of about 15 ml to about 150 ml relative to 1 ml of the cation exchanger.

14. The method of claim 11, wherein applying the first current to regenerate the cation exchanger further comprises applying a second current opposite to the first current to the first electrode and the second electrode, after a set time has passed.

15. The method of claim 11, further comprising:
applying a second current opposite to the first current to the first electrode and the second electrode, after regenerating the cation exchanger.

16. The method of claim 11, wherein adsorbing the hardness ions and regenerating the cation exchanger are repeated, and
wherein a second current opposite to the first current is applied to the first electrode and the second electrode while repeating the regenerating of the cation exchanger.

17. The method of claim 11, wherein one selected from the first electrolyte chamber and the second electrolyte chamber has hydroxyl (OH⁻) ions produced by electrolyzing water, and
the method further comprises passing the treated water through the OH⁻ ions, after regenerating the cation exchanger.

18. A method of driving an electrically regenerable water softening apparatus, comprising:
supplying inflow water to an ion exchange chamber of the electrically regenerable water softening apparatus to adsorb hardness ions in the inflow water;
stopping a flow of the inflow water; and
applying a first current to a first electrode and a second electrode while supplying a part of treated water from the ion exchange chamber into at least one of a first electrolyte chamber and a second electrolyte chamber to regenerate a cation exchanger of the electrically regenerable water softening apparatus.

19. The method of claim 18, wherein the inflow water is supplied at a flow velocity of about 3 ml/min to about 30 ml/min relative to 1 ml of the cation exchanger.

20. The method of claim 18, wherein the inflow water is supplied at a flow rate of about 15 ml to about 150 ml relative to 1 ml of the cation exchanger.

21. The method of claim 18, wherein applying the first current to regenerate the cation exchanger further comprises applying a second current opposite to the first to the first electrode and the second electrode, after a set time has passed.

22. The method of claim 18, further comprising applying a second current opposite to the first current to the first electrode and the second electrode, after regenerating the cation exchanger.

23. The method of claim 18, wherein adsorbing the hardness ions and regenerating the cation exchanger are repeated, and
wherein a second current opposite to the first current is applied to the first electrode and the second electrode while repeating the regenerating of the cation exchanger.

24. The method of claim 18, wherein one selected from the first electrolyte chamber and the second electrolyte chamber has hydroxyl (OH⁻) ions produced by electrolyzing water, and
the method further comprises passing the treated water through the OH⁻ ions, after regenerating the cation exchanger.

25. The method of claim 18, further comprising applying a second current to the ion exchange chamber while supplying the inflow water.
